(19) United States
(12) Patent Application Publication
(10) Pub. No.: US 2024/0113388 A1
(43) Pub. Date: Apr. 4, 2024

(54) HIGH ENERGY-DENSITY LITHIUM-SULFUR BATTERY AND METHOD FOR MAKING THE SAME

(71) Applicants: City University of Hong Kong, Hong Kong (HK); The Hong Kong Polytechnic University, Hong Kong (HK)

(72) Inventors: Hua ZHANG, Hong Kong (HK); Zijian ZHENG, Hong Kong (HK); Zhuangchai LAI, Hong Kong (HK); Lei WANG, Hong Kong (HK)

(21) Appl. No.: 18/475,228

(22) Filed: Sep. 27, 2023

Related U.S. Application Data
(60) Provisional application No. 63/411,113, filed on Sep. 29, 2022.

(51) Int. Cl. H01M 50/403; H01M 10/052; H01M 50/414; H01M 50/46

(52) U.S. Cl. CPC H01M 50/403; H01M 10/052; H01M 50/414; H01M 50/461

(57) ABSTRACT

Lithium-sulfur (Li—S) batteries using unconventional-phase transition metal dichalcogenides (TMDs), such as 1T′-WS₂, as the functional layer on the separator. The unique atomic structure of 1T′-WS₂ facilitates the strong immobilization and excellent catalytic ability in the conversion of polysulfide intermediates during cycling. Furthermore, the self-assembling of 1T′-WS₂ greatly decreases the internal porosity, minimizing the uptake of electrolyte, which can further guarantee the performance of the battery under lean electrolyte conditions. As a result, a cell based on the 1T′-WS₂ shows improved performances under high sulfur loading and lean electrolyte conditions. A cell with 12 mg cm⁻² mass loading of S with only 25% oversized Li metal anode can deliver specific energy of at least 400 Wh kg⁻¹ and 820 Wh L⁻¹, which is among the best of reported Li—S batteries.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

The present application claims priority from the U.S. Provisional Patent Application No. 63/411,113 filed on 29 Sep. 2022, and the disclosure of which is incorporated herein by reference in its entirety.

### FIELD OF THE INVENTION

The present invention relates to Lithium-sulfur (Li—S) batteries, and, more particularly, to high energy-density Li—S batteries using separator modified with transition metal dichalcogenides.

### BACKGROUND OF THE INVENTION

Li—S batteries are one of the most promising candidates for the next-generation battery technology to realize high energy density because of the high theoretical specific energy (2600 Wh kg¹), high natural abundance, and low cost of sulfur. However, current drawbacks of Li—S batteries, such as the poor conductivity of sulfur and its discharge product Li₂S, the dissolution and shuttling of lithium polysulfides (LiPSs, i.e., Li₂Sn, 4<n<8) intermediates, and the sluggish cathode redox kinetics have resulted in the low utilization of active sulfur, poor rate performance, and fast irreversible capacity fade, which drastically hinders their practical application.

Some strategies have been developed to alleviate the shuttling of LiPSs and improve the conductivities of sulfur, such as introducing new electrolyte systems, designing host materials, and modifying the battery separators. Among them, the modification of separators with highly conductive materials is an effective and promising route to realize batteries with high energy density for two reasons. First, the modified separator layer can provide an extra “current collector” above the electrode, which could shorten the diffusional pathways of the electrons. Second, the mass of the modified separator layer can be maintained at a relatively low level with the increase of the active materials in the electrodes. For example, conventional-phase transition metal dichalcogenides (TMDs) such as 2H-WS₂ and 2H-MoS₂ based composites have been applied in the modification of separators for enhanced performance of Li—S batteries. However, due to their limited catalytically active sites for the conversion of polysulfides and their intrinsically low conductivity, the resultant modified separators usually show limited electrochemical performance. Typically, the addition of binders and conductive additives (e.g., carbon nanotubes) is necessary. As a result, these layers possess a highly porous structure, requiring a large volume of electrolyte (E/S ratio>15 μL mg⁻¹, Table 1) to infiltrate the layers and guarantee the ionic pathways between cathodes and anodes. Therefore, Li—S batteries based on these separators usually exhibit low energy densities (FIG. 1), which are much lower than commercial lithium-ion batteries (˜250 Wh kg⁻¹), restricting the use of high-energy Li—S batteries for practical and portable applications.

TABLE 1
The summary of the E/S ratio in the reported work for the modification of
separator in the Li-S batteries

| | E/S | |
|---|---|---|
| Separators | (μL mg⁻¹) | References |
| CBBC/PP | 20 | J. Colloid Interface Sci. 2021, 585, 43. |
| MWCNT/CeO2/PP | 25 | J. Membr. Sci. 2020, 597, 117646 |
| PSU/PP | 15 | ACS Nano 2021, 15, 1358 |
| Composite separator | 15 | Chem. Eng. J. 2020, 382, 122918. |
| based on F-doped | | |
| and F-Mn₃O₄- | | |
| co-doped PMIA | | |
| Nano-MgO/AB/ | 20 | Nanoscale Adv. 2019, 1, 1589. |
| Celgard 2400 | | |
| PP-TA/Au | 25 | Polymers 2019, 11. |
| SnS/PCNS/Celgard | 20 | Adv. Funct. Mater. 2020, 30, 2006297 |
| Ti₃C₂@iCON/PP | 15 | Adv. Mater. 2021, 33, 2007803 |
| TiN@C/G-PP | 56 | Electrochim. Acta 2021, 384, 138187. |
| Ni₃(HITP)₂/PP | 20 | Adv. Energy Mater. 2018, 8, 1802052. |
| TpPa-SO₃Li/PP | 20 | Nano Lett. 2021, 21, 2997 |

### SUMMARY OF THE INVENTION

The present invention provides high-energy Li—S batteries using unconventional-phase TMDs, e.g., 1T′-phase TMDs, as modifiers to create high-performance separators. In the modification process, the 1T′-phase TMDs are firstly centrifuged to obtain a suspension of nanosheets and subsequently filtered on porous separators to obtain functionalized separators; the fabrication process is straightforward such that it may be easily scaled to meet commercial-scale manufacture. In addition, the self-assembly of 1T′-phase TMD nanoflakes decreases the internal porosity and strongly adheres to the separator, ensuring separator integrity during bending and minimizing the uptake of electrolytes. Importantly, the 1T′-phase TMDs coating layer can effectively catalyze the conversion of polysulfides and trap soluble polysulfides due to its phase engineering properties, especially in conditions with a lean electrolyte, which would effectively improve the energy density of Li—S battery in both volume and gravimetry compared with the previous reports. Due to the robust mechanical properties, the modified separator of the present invention can facilitate the fabrication of flexible Li—S batteries.

In accordance with a first aspect, the present invention, provides a high energy-density lithium-sulfur battery having a cathode including sulfur and an anode including lithium metal; a separator positioned between the cathode and the anode. The separator is modified by a self-assembled 1T′-phase transition metal dichalcogenide layer such that the battery has an energy density of at least 400 Wh kg⁻¹ and 820 Wh L⁻¹.

In a further aspect, the electrolyte is provided in an amount constituting a lean electrolyte battery condition.

In a further aspect, the electrolyte is a lithium-containing electrolyte.

In a further aspect, the 1T′-phase transition metal dichalcogenides include one or more of WS₂, WSe₂, MoS₂, MoSe₂, WS₂ₓSe₂₍₁₋ₓ₎, MoS₂ₓSe₂₍₁₋ₓ₎, TaS₂, TaSe₂, TiS₂, TiSe₂, ReS₂, ReSe₂, NbS₂, and NbSe₂.

In a further aspect, the 1T′-phase transition metal dichalcogenide layer does not include additional conductive materials.

In a further aspect, the separator is a polypropylene or polyethylene separator.

In accordance with a second aspect, the present invention provides a method of making a high energy-density lithium-sulfur battery including providing a cathode including sulfur and providing an anode including lithium metal. A separator is positioned between the cathode and the anode, the separator being fabricated by filtering a suspension including 1T′-phase transition metal dichalcogenides through a porous separator such that the 1T′-phase transition metal dichalcogenides self-assemble to form a 1T′-phase transition metal dichalcogenide layer on the porous separator.

In a further aspect, the 1T′-phase transition metal dichalcogenides include one or more of WS₂, WSe₂, MoS₂, MoSe₂, WS₂ₓSe₂₍₁₋ₓ₎, MoS₂ₓSe₂₍₁₋ₓ₎, TaS₂, TaSe₂, TiS₂, TiSe₂, ReS₂, ReSe₂, NbS₂, and NbSe₂.

In a further aspect, the suspension including 1T′-phase transition metal dichalcogenides is a suspension of 1T′-phase transition metal dichalcogenide flakes.

In a further aspect, the 1T′-phase transition metal dichalcogenide layer does not include additional conductive materials.

In a further aspect, the separator is a polypropylene or polyethylene separator.

In a further aspect, an electrolyte is added to the battery in an amount constituting a lean electrolyte battery condition.

### BRIEF DESCRIPTION OF THE DRAWINGS

Embodiments of the invention are described in more details hereinafter with reference to the drawings, in which:

FIG. 1 shows the estimated energy densities of the Li—S batteries with different amounts of electrolyte.

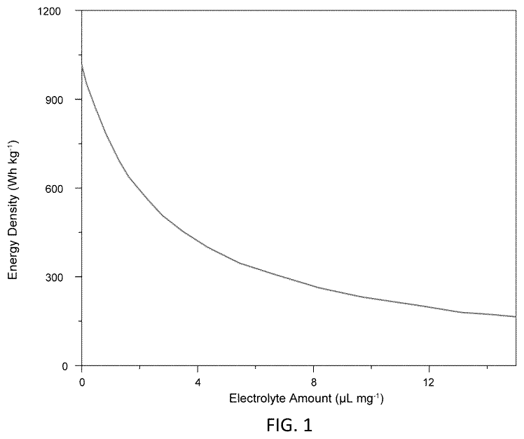

FIGS. 2A to 2C show the scanning electron microscopy (SEM)image, high resolution transmission electron microscopy (HRTEM) image and selected area electron diffraction (SAED) pattern of the as-prepared 1T′-WS₂ crystals; FIG. 2D shows the X-ray diffraction (XRD) pattern for the obtained 1T′-WS₂ and 2H-WS₂ crystals respectively; FIG. 2E shows the Raman spectra for obtained 1T′-WS₂ and 2H-WS₂ crystals respectively; FIG. 2F shows the I-V curves of the 1T′-WS₂, 2H-WS₂ and Au samples respectively. Inset of FIG. 2F shows the scheme of the instrument for the I-V measurements.

FIGS. 3A and 3B show the SEM image and HRTEM image of the obtained 2H-WS₂ crystals respectively.

FIG. 4A shows UV-Vis of the leaching electrolyte after the absorption of polysulfides (inset of FIG. 4A shows photos of the pristine Li₂S₄ electrolyte, Li₂S₄ electrolyte mixed with 1T′-WS₂, and Li₂S₄ electrolyte mixed with 2H-WS₂); FIG. 4B shows the X-ray photoelectron spectroscopy (XPS) fine spectrum of W 4f before and after the absorption of Li₂S₄ electrolyte; FIG. 4C shows the summary of the binding energies between the polysulfides and different absorbents;

FIG. 4D shows the characterization of the catalytic ability using the symmetrical cells; FIG. 4E shows the precipitation of solid lithium sulfide on the 1T′-WS₂ modified electrode; FIG. 4F shows the precipitation of solid lithium sulfide on the 2H-WS₂ modified electrode; and FIG. 4G shows landscape of the Gibbs energy at different stages during the discharging process.

FIG. 5 shows calculated models for the adsorption of polysulfide on the 1T′-WS₂.

FIG. 6A shows a SEM image of the 1T′-WS₂ modified separator with layer-by-layer structure; FIG. 6B shows cross-sectional SEM image of the 1T′-WS₂ modified separator; FIG. 6C shows a SEM image and the corresponding elemental mapping images of W and S (the scale bar in the mapping represents 60 m; FIG. 6D shows uptake of electrolyte of separators with different modification layers.

FIGS. 7A and 7B show SEM image and cross-sectional image of the carbon nanotube (CNT) modified separator respectively.

FIG. 8 shows a schematic image of the structures of the separator modified with conventional nanomaterials and the uptake of electrolyte in the corresponding structure. The right pies show the distribution in the corresponding structures.

FIGS. 9A to 9C shows the permeation of LiPSs on bare separator, separator modified by conventional 2H-WS₂, and separator modified with 1T′-WS₂ according to the present invention, respectively.

FIG. 10 shows a thermogravimetric curve of the S/C active materials. The loss of the mass is caused by the evaporation of S in the composite.

FIG. 11A shows SEM image of top view of the S cathodes; FIGS. 11B to 11D show SEM images of cross-sectional view of the S cathode with loadings of 3 mg cm⁻², 5 mg cm⁻² and 12 mg cm⁻², respectively.

FIG. 12A shows SEM image of top view of the Li metal deposited on the self-regulating alloy modified textile based current collector (anode); FIGS. 12B to 12D show SEM images of cross-sectional view of the anode with capacities of 6 mAh cm⁻², 10 mAh cm⁻² and 20 mAh cm⁻², respectively.

FIG. 13A shows the cycling stability of the Li metal anode at the capacity of 5 mAh cm⁻²; FIG. 13B shows the cycling stability of Li metal anode at 80% depth of discharge; FIG. 13C shows the cycling of the Li metal anode at different current densities for the capacity of 2 mAh cm⁻².

FIG. 14 shows cyclic voltammetry of the cells based on different separators, the cell based on the 1T′-WS₂ shows the large area and small interval, which demonstrates the enhanced kinetics in the cell based on the 1T′-WS₂.

FIGS. 15A and 15B show cyclic voltammograms at various voltage scan rates and corresponding linear fits of the peak currents of Li—S batteries with bare separator respectively;

FIGS. 15C and 15D show cyclic voltammograms at various voltage scan rates and corresponding linear fits of the peak currents of Li—S batteries with 2H-WS₂ modified separator respectively;

FIGS. 15E and 15F show cyclic voltammograms at various voltage scan rates and corresponding linear fits of the peak currents of Li—S batteries with 1T′-WS₂ modified separator respectively.

FIGS. 16A and 16B show calculated diffusional pathways of the Li ions on the 1T′-WS₂ and 2H-WS₂ crystals respectively; FIG. 16C shows the summary of the energy barrier of the diffusion of Li ions on the 1T′-WS₂ and 2H-WS₂ crystals.

FIG. 17 shows galvanostatic charge/discharge (GCD) curves of the cell with 2H-WS₂ modified separator under high mass loading of 12 mg cm⁻². The insert of FIG. 17 exhibits the detailed information and estimation of energy density of the cell.

FIG. 18A shows of GCD profiled of different cells at 0.05 C; FIG. 18B shows summary of the ratios of the low plateau capacity (Q_{L}) to the high plateau capacity (Q_{H}) for different cells.

FIG. 19 shows evaluation results of the cycling stability of the cells.

FIGS. 20A and 20B show images of cycled Li metal in the cell with 1T′-WS₂ modified separator; FIGS. 20C and 20D show images of cycled Li metal in the cell with bare separator;

FIGS. 20E and 20F show images of cycled Li metal in the cell with 2H-WS₂ modified separator.

FIG. 21 shows rate capability of the cells based on different separators.

FIG. 22 shows the cycling stability of the cells based on the 1T′-WS₂ with high mass loading of 12 mg cm⁻².

FIG. 23 shows the comparison of the performances in the gravimetric energy density and volumetric energy density with other battery systems and S based batteries.

FIG. 24A shows the scheme of structure of the flexible Li—S battery; FIG. 24B shows the cycling stability of the flexible pouch cell, during which the battery is bent at 5 mm and 1 mm for 10 cycles; FIG. 24C shows the light-emitting diodes (LEDs) array powered with two flexible pouch cells in series at different flexing states.

### DETAILED DESCRIPTION

In the following description, embodiments of the present invention are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The present invention relates to unconventional-phase transition metal dichalcogenide (TMD)-modified separators for high-energy Li—S batteries and flexible Li—S batteries. The unconventional 1T′-phase TMDs include WS₂, WSe₂, MoS₂, MoSe₂, WS₂ₓSe₂₍₁₋ₓ₎, MoS₂ₓSe₂₍₁₋ₓ₎, TaS₂, TaSe₂, TiS₂, TiSe₂, ReS₂, ReSe₂, NbS₂, and NbSe₂.

Synthesis of 1T′-phase transition metal dichalcogenides may employ a gas-solid reaction technique. In the gas-solid reaction, precursors of the metal component and the chalcogen(s) are mixed in a predetermined ratio (based on the selected final composition); the mixture is heated to an elevated temperature (for example, 400 to 800° C.) for an extended period of time (e.g., 70 to 120 hours) under vacuum conditions (e.g., 10⁻⁶ to 10⁻⁵ torr) to produce a precursor. The precursor is further annealed in a reducing atmosphere (e.g., hydrogen and an inert gas) at an elevated temperature (e.g., 500 to 800° C.) for a period of time (5 to 15 hours). The resultant product is washed and cleaned to remove any precursor residue along with leaching to further purify the product, yielding 1T′-phase TMD crystals.

To load the 1T′-TMDs on a separator, the 1T′-phase TMDs are dispersed in a dispersant and centrifuged to obtain a suspension. The separator may be selected from any commercially available porous separators, such as polypropylene separator, a polyethylene separator or cellulose based separator. The porous separator is then used as a filtering membrane to filter the suspension with the aid of a vacuum. Nanoflakes of 1T′-TMDs undergo a self-assembling process and are firmly attached to the porous separator. Self-assembly is a process where atoms, molecules or nanoscale building blocks spontaneously organize into an ordered structures or pattern with nanometer features. In addition, the self-assembly of the 1T′-TMDs nanoflakes enables a strong adhesion to the separator and lower the internal porosity, which can ensure its integrity in a bending state, and thus minimize the uptake of electrolyte at the same time.

The unique configuration of the atoms in 1T′-WS₂ endows outstanding catalytic ability and chemical adsorption towards the LiPSs. The strong interaction between 1T′-TMD nanoflakes leads to the dense packing on a porous separator, which effectively decreases the internal porosity and enhances the mechanical properties of the separator, lowering the trapping of electrolytes in the modification layer and blocking the shuttling of LiPSs.

It is important to note that the present modification of separators does not require conductive additives such as carbon nanomaterials and polymeric binders because the 1T′-phase TMDs possess good conductivity. As a result, due to the absence of these further additives the porosity of the coating layer is lowered, resulting in a decrease in electrolyte uptake in the separator.

The unique atomic structure of 1T′-phase TMDs enables rapid conversion/catalysis of polysulfide under lean electrolyte conditions, which can greatly enhance the energy density. As used herein, the expression “lean electrolyte” relates to a low volume of electrolyte with a low electrolyte/sulfur ratio. The use of lean electrolyte conditions is essential for commercial-grade Li—S batteries.

Fabrication of 1T′-WS₂ Crystals

K₂WO₄ and S powders with a molar ratio of 1:4 were mixed and sealed in a quartz ampoule under the pressure of 10⁻⁶ to 10⁻⁵ torr. Then the sealed ampoule was annealed at 500° C. for 96 hours to obtain the precursor. Then the precursor was loaded into an alumina crucible in the middle of a quartz tube and heated at 750° C. in an atmosphere with H₂/Ar mixed gas (1:4 in volume) for 10 hours. After quickly cooling down to room temperature, the resulting product was thoroughly washed with Milli-Q water until the pH value of the suspension reached 7 to 8. Then, the resulted product was transferred to an I₂ acetonitrile solution (4 mmol, 15 ml) for another 24 h to remove the potassium residue in the composite, and subsequently leached with Milli-Q water to obtain the final 1T′-WS₂ crystals.

Fabrication of 2H-WS₂ Crystals

To obtain a control sample, 2H-WS₂ crystals are obtained by annealing the as-prepared 1T′-WS₂ crystals at an elevated temperature in an inert atmosphere (e.g., an argon atmosphere) for a period of time (e.g., 4 hours).

Preparation of 1T′-WS₂ Modified Separator

500 mg of 1T′-WS₂ are dispersed in 200 ml of isopropanol by stirring at a speed of 500 rpm. After dispersion was centrifuged at 2,000 rpm to remove the bulk crystals to obtain suspension of 1T′-WS₂, a square piece of porous polypropylene separator with a size of 25 cm² is attached to a glass filter and a glass cup was sealed at the top. A portion of the suspension was poured into the cup and filtered by the vacuum, in which the nanoflakes of 1T′-WS₂ underwent the self-assembling process and were firmly attached to the separator.

Characterization of WS₂ Crystals

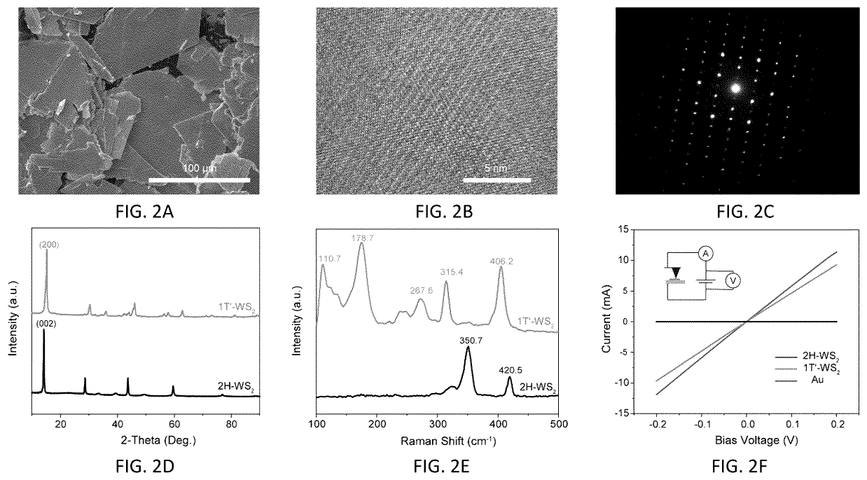

The 1T′-WS₂ crystals prepared using the gas-solid reaction are shown in SEM image in FIG. 2A. The lateral size of the 1T′-WS₂ crystals can be as large as a few hundreds of micrometers. The HRTEM image and the SAED patterns clearly reveal the characteristic features of the 1T′-phase structure (FIGS. 2B and 2C). The powder XRD pattern of the as-prepared 1T′-WS₂ was also consistent with a standard pattern with the (200) diffraction peak located at 15.02° (top curve in FIG. 2D), which is in good agreement with the previously reported 1T′-WS₂. Furthermore, five peaks located at 110.7, 178.7, 267.6, 315.4 and 406.2 cm⁻¹ were observed from the Raman spectrum of the as-prepared 1T′-WS₂ (top curve in FIG. 2E), which are similar to a previously reported result, revealing the 1T′-phase structure of the WS₂. These results confirm the high purity of the as-prepared 1T′-WS₂.

It is noteworthy that the (002) diffraction peak located at 14.3° belonging to the as-prepared 2H-WS₂ samples (lower curve in FIG. 2D) and two characteristic Raman peaks of 2H-WS₂, i.e., 350.7 (E¹_{2g}) and 420.5 (A_{1g}) cm⁻¹ (lower curve in FIG. 2E), are observed from the XRD pattern and Raman spectrum, respectively, demonstrating the complete phase transformation from 1T′ to 2H phases.

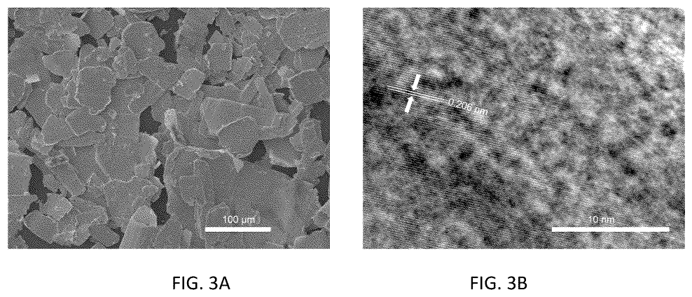

As shown in the SEM image (FIG. 3A), the obtained 2H-WS₂ inherits the original morphology from the as-prepared 1T′-WS₂ nanoflakes (FIG. 2A). The 2H-phase structure of the obtained WS₂ samples were further revealed by the HRTEM image (FIG. 3B), in which the clear lattice fringes with a spacing of 0.21 nm can be observed, indicating the (006) plane of the 2H-WS₂. In addition, the as-prepared 1T′-WS₂ showed much smaller resistance compared to the 2H-WS₂, which is even comparable to a bare Au electrode (upper diagonal line in FIG. 2F).

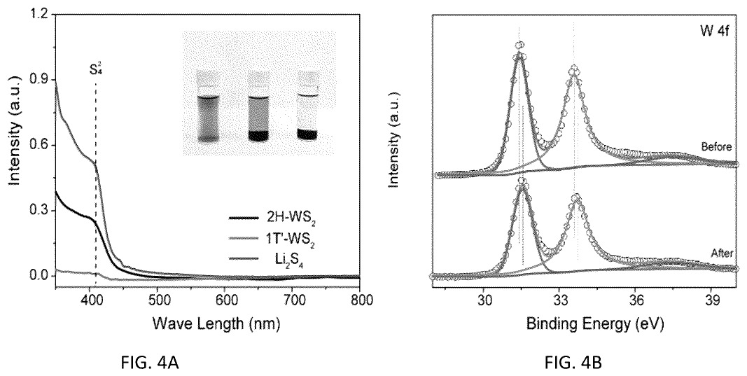

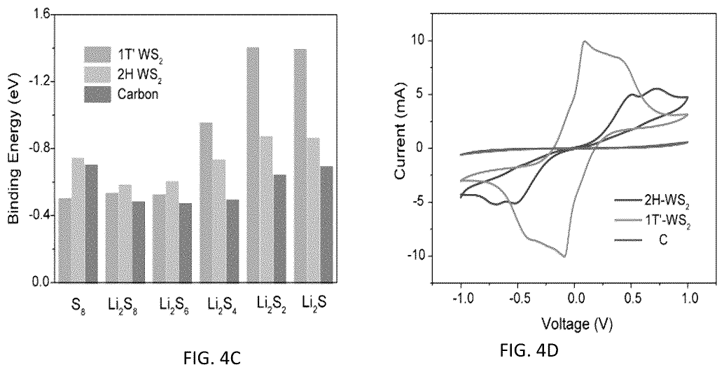

The absorption ability is critical to alleviate the shuttling of polysulfides in the electrolyte and thus stabilize the cycling of a high-energy Li—S battery. To evaluate the absorption ability of polysulfides for different samples, both 2H-WS₂ and 1T′-WS₂ powders were mixed with a Li₂S₄ solution. As shown in the inset of FIG. 4A, the Li₂S₄ solution mixed with 1T′-WS₂ powders exhibited an almost transparent color, while the one mixed with 2H-WS₂ showed clear deep yellow color, revealing the much higher absorption ability of 1T′-WS₂ toward Li₂S₄ than that of the 2H-WS₂. This result is further confirmed by the UV-Vis test (FIG. 4A), in which the absorption peak corresponding to Li₂S₄ in the leaching solution of 1T′-WS₂ was much lower than that of the 2H-WS₂, demonstrating that 1T′-WS₂ absorbed much more polysulfide than the 2H-WS₂ did (FIG. 4A).

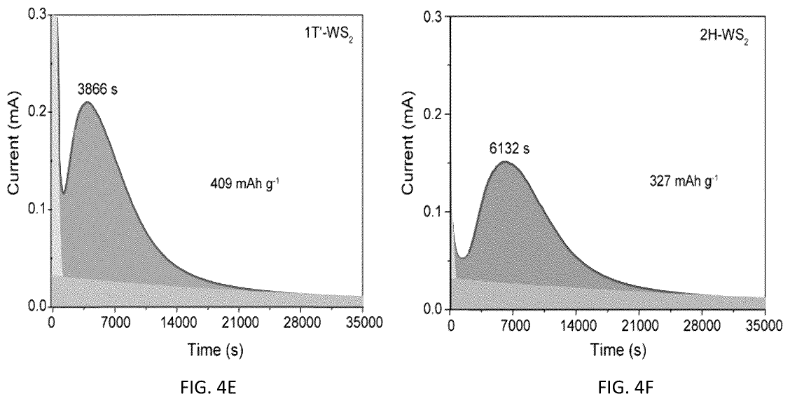

Moreover, there is an obvious positive shift of the W 4f peaks in the XPS fine spectra with the Li₂S₄ adsorption (FIG. 4B), revealing the strong chemical interaction of Li₂S₄ with the 1T′-WS₂. In addition, density functional theory (DFT) calculations were performed to investigate the difference in binding strength of the LiPSs with 2H- and 1T′-WS₂. The optimized configurations of the polysulfides are schematically illustrated in FIG. 5, in which the Li cations firmly bond with the S atoms on the surface of WS₂. As shown in FIG. 4C, the 1T′-WS₂ exhibits comparable binding energies with long-chain polysulfides with 2H-WS₂, but much higher binding energies for the short-chain and middle-chain polysulfides could be observed in the case of 1T′-WS₂, confirming the intrinsically high absorption ability of polysulfides.

The catalytic ability of the modification layer towards the polysulfides can effectively eliminate the shuttling and boost the electrochemical kinetics to enhance the battery performance under the lean electrolyte. As shown in FIG. 4D, a symmetrical cell with 1T′-WS₂ electrodes exhibited two pairs of redox peaks at the potentials of around ±86 and ±400 mV, respectively, which were much lower than the potential intervals for a symmetrical cell with 2H-WS₂ electrode (around ±523 and ±700 mV), indicating much faster kinetics of 1T′-WS₂ towards the conversion of polysulfides in Li—S battery.

Furthermore, the catalytic performance of WS₂ with different phases was evaluated by monitoring the precipitation process of Li₂S on the 1T′-WS₂ and 2H-WS₂ electrodes (FIGS. 4E and 4F). It was found that the accumulated capacity of the 1T′-WS₂ electrodes reached 409 mAh g⁻¹ in the first 35000 s (FIG. 4E), which is far larger than that of the 2H-WS₂ electrodes (327 mAh g⁻¹) in the same time interval (FIG. 4F), proving that the superior catalytic activity of 1T′-WS₂ toward polysulfides in the solution. In addition, the peak current of 1T′-WS₂ electrode appears much earlier than the 2H-WS₂ electrode (3866 s vs. 6132 s), which further confirmed the enhanced catalytic kinetics in the conversion of polysulfides.

To reveal the mechanism of the superior catalytic performance of 1T′-WS₂, DFT calculations of the Gibbs energy at different reaction stages in the conversion process were performed. FIG. 4G showed the relative Gibbs energy landscape for the discharging process from the S₈ to the solid-state Li₂S₂ on the surface of 1T′-WS₂. The reactions from the solid S₈ to the Li₂S₈ and Li₂S₄ were more thermodynamically favorable on the surface of 1T′-WS₂ compared to that of the 2H-WS₂. Specifically, the 1T′-WS₂ exhibited a smaller energy barrier (0.02 eV) compared with the 2H-WS₂ (0.21 eV) in the step from the soluble Li₂S₄ to the solid Li₂S₂, which demonstrates that the endothermic precipitation process of solid sulfides is thermodynamically more favorable on the surface of 1T′-WS₂. Moreover, 1T′-WS₂ can provide fast electron transfer between the LiPSs and catalyst owing to its metallic properties, which can further facilitate the weakening of the Li—S bonds of LiPSs. As a result, 1T′-WS₂ can significantly decrease the energy barrier for the reduction of LiPSs, facilitating the ease precipitation of Li₂S and low viscosity of the electrolyte, which eventually improve the reversibility of reactions in the Li—S battery.

Characterization of the 1T′-WS₂ Modified Separator

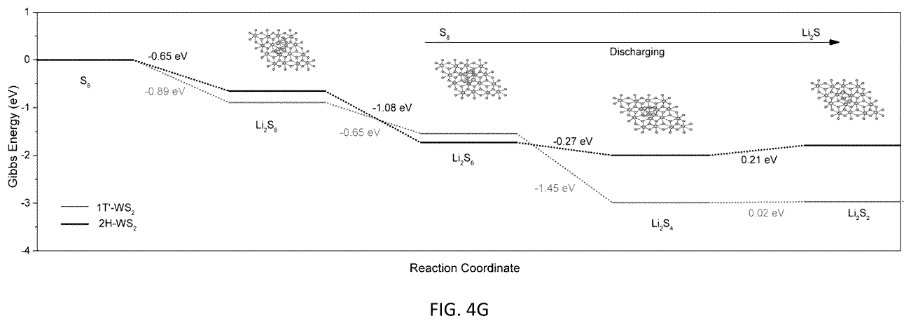

Referring to FIGS. 6A to 6C for characterization of the 1T′-WS₂ modified separator. As shown in FIGS. 6A and 6B, the 1T′-WS₂ formed a dense layer-by-layer structure on the separator with a layer thickness of ˜1 m, which was firmly attached to the separator when the 1T′-WS₂ nanoflakes were loaded onto the separator by simple vacuum-assisted filtration. Furthermore, the elemental mappings of W and S (FIG. 6C) confirm that the 1T′-WS₂ nanoflakes were assembled into a continuous layer uniformly, which can provide an extra current collector above the electrode and significantly shorten the diffusion pathways for the electrons benefiting from the metallic nature of the 1T′-WS₂.

It was determined that the self-assembly of the 1T′-WS₂ greatly lowers the internal porosity of the modification layer and thus decreases the uptake of the electrolyte, leaving more electrolyte contained in the electrode during operation, enhancing the electrochemical performance in a lean electrolyte condition. As shown in FIG. 6D, the separator modified with 1T′-WS₂ absorbed the least amount of electrolyte (96.9%) after complete infiltration with the electrolyte as compared with to the bare separator (265.6%) and a commonly-used carbon nanotube (CNT) separator (315%). Generally, to guarantee the conductivity of the modified separator layer, the loading amount of the modification nanomaterials on the traditional separators should be large.

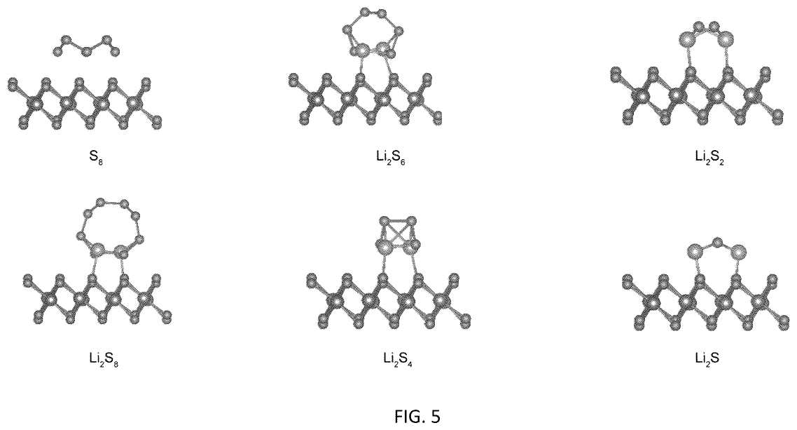

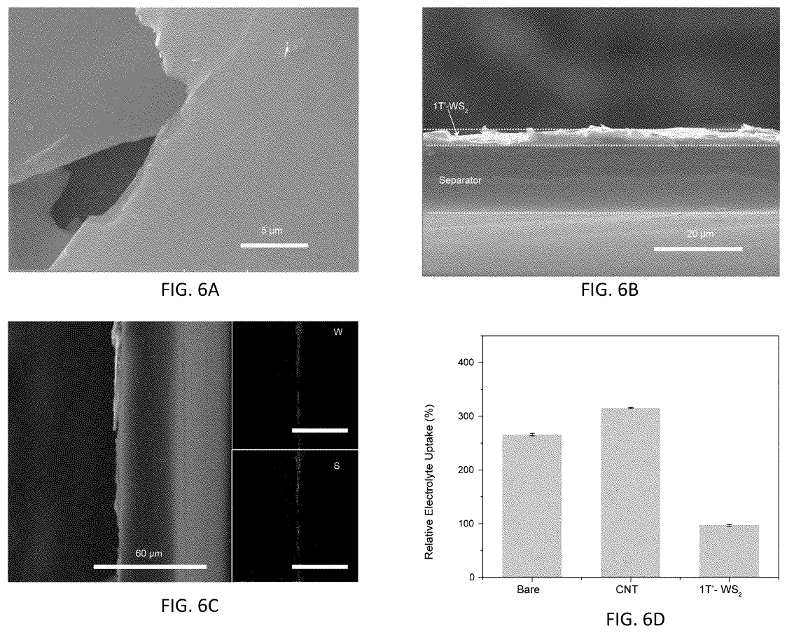

However, due to their small size, the packing of those nanomaterials results in a large amount of internal void space inside the modification layer (FIGS. 7A and 7B). Referring to FIG. 8, as a result, separators modified by traditional nanomaterials uptake a large quantity of electrolyte in order to fully infiltrate the internal pores to ensure smooth pathways for Li cations, leading to a small portion of the remaining electrolyte to take part in the electrochemical reaction in the electrodes, resulting in worsened performance under a lean electrolyte condition. In contrast, the separator of the present invention modified by the 1T′-WS₂ nanoflakes provides more electrolyte to the cathode to decrease viscosity and accelerate the conversion of LiPSs to achieve high-energy density.

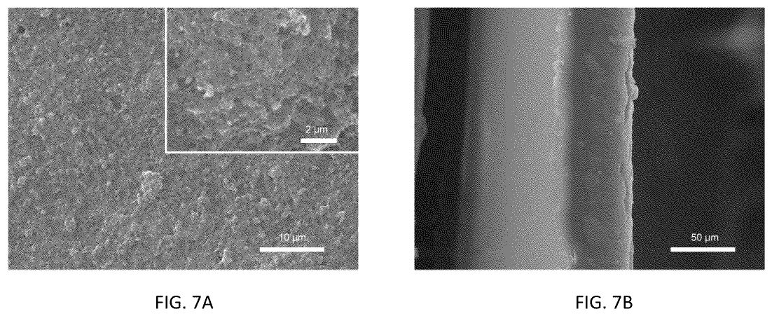

The separator modified with 1T′-WS₂ can effectively prevent the shuttling of LiPSs during cycling. Specifically, permeation experiments were conducted using H-type electrolytic cell devices under similar conditions, where soluble polysulfide in the left chamber slowly diffuses into the right chamber when a commercial PP separator is used (FIG. 9A). The electrolyte in the right cell with a separator modified by conventional 2H-WS₂ can only maintain a colorless condition for around 3 hours and then turned pale yellow after 4 hours, indicating that a slight amount of LiPSs had diffused into the electrolyte (FIG. 9B). In contrast, for the cell with the inventive separator modified with 1T′-WS₂, the inside electrolyte remained transparent even after 6 hours (FIG. 9C), demonstrating the excellent effective blocking effect, which could be ascribed to the dense packing and the outstanding immobilizing ability of LiPSs by the 1T′ WS₂.

Preparation of Batteries Employing 1T′-WS₂

Preparation of ultrathin current collector: The PET textile was firstly cleaned with oxygen plasma for 7 minutes to remove the impurities on the surface. Then the PET textile went through a typical polymer-assisted metal deposition (PAMD) process to be modified with Ni on the surface. In a typical PAMD process, the PET was first silanized by being immersed in a solution containing 4% (v/v) [3-(methacryloyloxy)propyl]trimethoxysilane in a mixed solvent (Vₑₜₕₐₙₒₗ: V_{acetic acid}: V_{DI water}=95:1:4) for 1 hour at room temperature. After rinsing in the DI water several times, the silanized PET was further immersed in an aqueous solution of [2-(methacryloyloxy)ethyl]trimethyl ammonium chloride (METAC, 20 wt %). Potassium persulfate (2 g L⁻¹) was added to initialize the polymerization of METAC at 80° C. After 1 hour, PMETAC-coated PET was further washed with DI water and then dipped into an aqueous solution of (NH4)₂PdCl₄ (5 mM) in dark to load the catalyst on the surface. The residual [PdCl₄]²⁻ was removed by washing in the DI water. And finally, the [PdCl₄]²⁻ loaded PET was immersed into a mixed aqueous solution of A and B (pH=7.5) for 30 minutes, where solution A comprised of NiSO₄·6H₂O (80 g L⁻¹), sodium citrate (40 g L⁻¹), and lactic acid (20 g L⁻¹) and solution B was dimethylamine borane (1.5 g L⁻¹) in water. The Ni coated PET was further immersed into an ethanol solution containing antimony trichloride (SbCl₃, 2 g L⁻¹) at 85° C. for 4h and subsequently washed with ethanol to remove the SbCl₃ to obtain the self-regulating alloy coated current collector.

Preparation of cathode: The S and acetylene carbon black with a weight ratio of 90.5:9.5 was grounded to form a homogeneous mixture. The mixture was then sealed in a quartz ampoule and then heated to 155° C. and kept at that temperature for 12 hours to obtain the active materials for cathode. The obtained active materials, acetylene black, and binder Polyvinylidene fluoride at a weight ratio of 8:1:1 were mixed and ground in a mortar for 1 hour. Then the mixture was homogenized in solvent NMP with magnetic stirring overnight to form a slurry. Finally, the slurry was uniformly bladed on the PET-based current collector and dried in an oven for 12 hours under vacuum to form the cathode.

Preparation of anode: As for the Li metal anode, the self-regulating alloy modified the PET was assembled in the cell with Li metal foil as the counter electrode.

Preparation of electrolyte: The electrolyte was prepared by dissolving 1.0 M LiTFSI in dimethoxyethane (DME) and 1,3-dioxolane (DOL) (1:1 vol. %) with 2.0% LiNO₃ as additive. The deposition current was 1 mA cm⁻² and the time was controlled to deposit different amount of Li to pair with S cathode with different capacities. For example, to prepare Li₂S₆ solution as electrolyte in the symmetrical cell, lithium sulfide and sulfur at a molar ratio of 1:5 were mixed into the solvent of 1:1 (v/v) DOL and DME with 2% LiNO₃ as the additives under vigorous magnetic stirring at 50° C. overnight. The Li₂S₄ electrolyte used in the adsorption experiments was prepared following the similar procedure but the molar ratio of Li₂S and S was 1:3.

Evaluation of Electrochemical Performances

The long cycling stability of electrochemical performances of 1T′-WS₂ modified separator under high areal mass loading were tested in the coin cell (CR2025), which was assembled in the argon-filled glove box with water and oxygen below 0.1 ppm. The electrolyte was 1 M LiTFSI dissolved in 1:1 (v/v) DOL/DME with 2% LiNO3 as additive. For the evaluation of long cycling stability, the mass loading of S was 4 mg cm⁻², ratio of electrolyte to S (E/S) was 5 μL mg⁻¹ and the capacity of the Li metal was controlled to be 8 mAh cm⁻². In the test of cell with high areal mass loading of 12 mg cm⁻², the capacity of the Li metal anode was 20 mAh cm⁻² and the electrolyte to sulfur (E/S) ratio was strictly controlled to be 3.5 μL mg⁻¹. Before measurement, the cells were aged for several hours to guarantee the infiltration of electrolytes into the electrode. Cyclic voltammetry (CV) and electrochemical impedance spectroscopy (EIS) were performed on a CHI 760E electrochemical workstation (Shanghai CHI instruments, China). The GCD curves and cycling stability were evaluated by testing on the Neware battery tester (Shenzhen, China).

Symmetric cells were assembled in an argon-filled glove box using the WS₂ modified carbon paper with a mass loading of 1.0 mg cm⁻² as working and counter electrodes with 50 μL Li₂S₆ electrolyte. In the deposition experiment of Li₂S, the working electrode was WS₂ with different phases of modified carbon paper with a mass loading of 1.0 mg cm⁻² and the counter electrode was Li foil electrode. The cut off current in the experiments was set at 1e⁻⁵ A.

DFT calculation: All calculations were performed using the Vienna ab initio simulation package (VASP) code based on the DFT framework, with the exchange-correlation energy functional, which were described by generalized gradient approximation with Perdew-Burke-Ernzerhof (PBE) exchange-correlation function. A cut-off energy of 520 eV was employed for the plane-wave basis to ensure convergence. All the structures were optimized with energy and force convergence criterions of 10⁻⁵ eV and 0.02 eV Å⁻¹, respectively. For simulating the lithium polysulfide (including Li₂Sₓ, X=2, 4, 6, 8) and sulfur adsorption properties, (5×3×3) surfaces of 1T and 2H phase WSe₂ with vacuum thickness of 20 Å were designed, and the k-points of 3×3×1 and 5×5×1 were used for structure optimization and energy calculation, respectively.

The adsorption energy was calculated through the equation of E=E_{(Li+sub)}−E_{sub}−E_{Li2Sx}, where E_{(Li+sub)} is the total energy of the adsorbed system, E_{sub} is the energy of the optimized clean surface slabs and E_{Li2Sx} is the energy of lithium polysulfides.

The Gibbs free energy change (ΔG) of each elementary step was calculated by ΔG=ΔE+Δ ZEP−TΔS, where ΔE is the adsorption enthalpy difference, ΔZPE and ΔS are the difference of zero-point energies and the change of entropy, respectively, which were estimated from the vibrational frequencies, and T=298.15 K. For mimicking the diffusion process, the climbing image nudged elastic band (CI-NEB) method was applied for computing the diffusion barrier.

The excellent immobilization, catalytic conversion, total blocking of LiPSs and the low uptake of electrolyte provided by the 1T′-WS₂ modified separator greatly improve the electrochemical performance of a Li—S battery under a lean electrolyte condition.

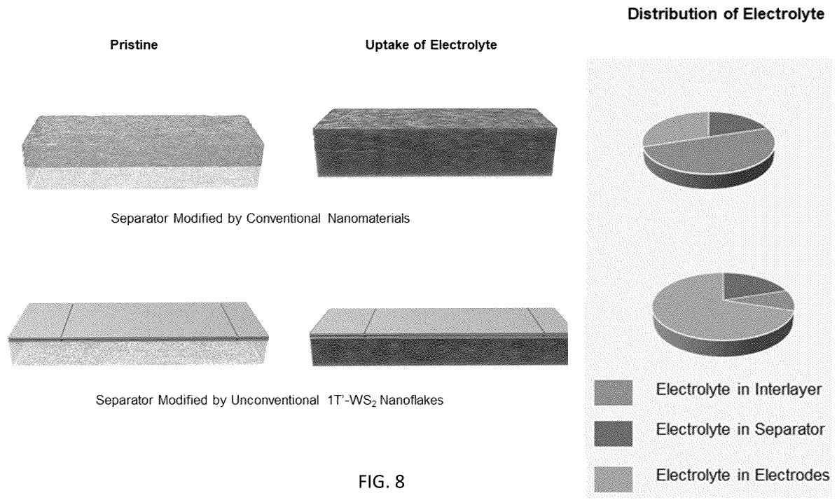

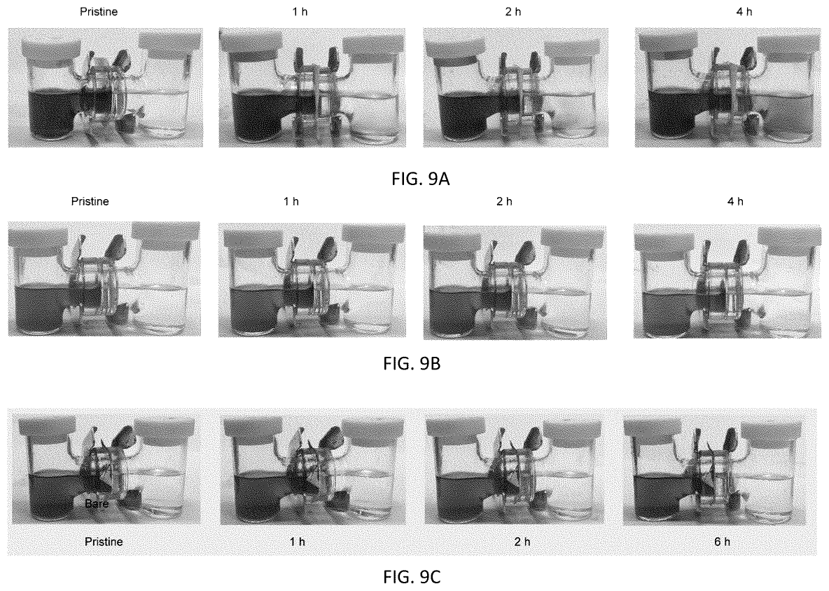

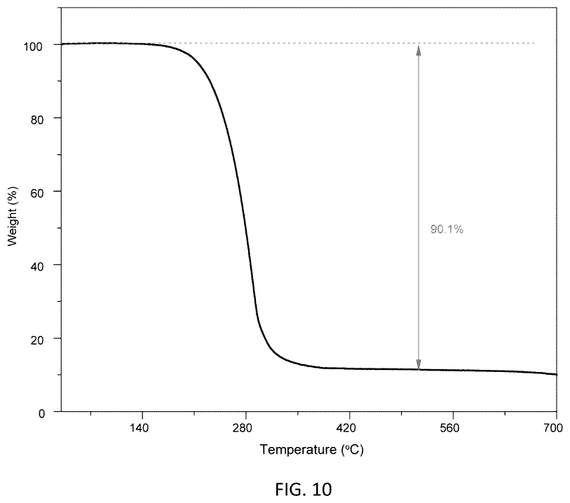

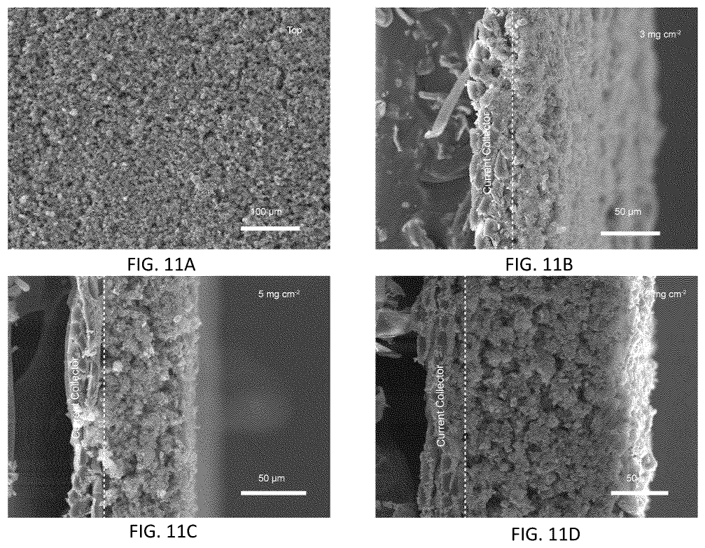

As a proof-of-concept application, the separator modified by 1T′-WS₂ was applied to a full cell. A sulphur/carbon (S/C) composite with a high sulfur content of over 90% (FIG. 10) was doctor bladed to a current collector to prepare a cathode (FIGS. 11A to 11D). Different amounts of Li metal were strictly controlled and electrochemically deposited on the self-regulating alloy-modified fabric current collectors to fabricate an ultrathin and ultra-stable Li metal anode as the counter electrode (FIGS. 12A to 12D) to control the depth of discharge (DOD) to ensure the high energy of the device, which could be deeply cycled at high areal capacity (16 mAh cm⁻²@80% DOD) and tolerant high current density (10 mA cm⁻², FIGS. 13A to 13C).

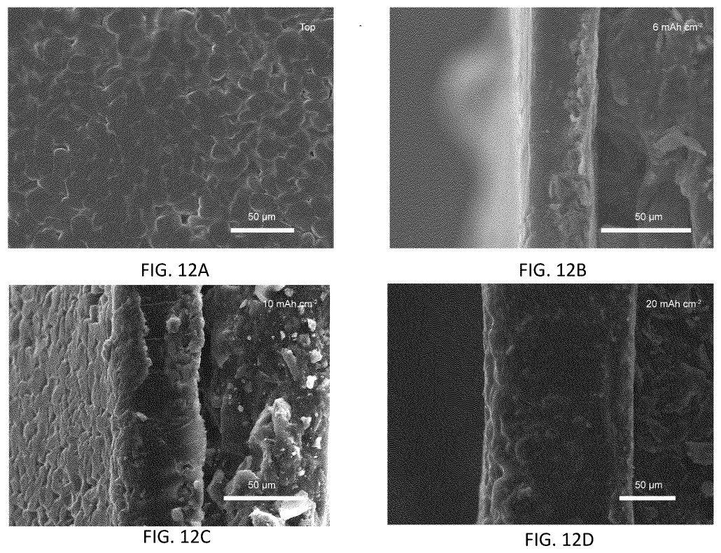

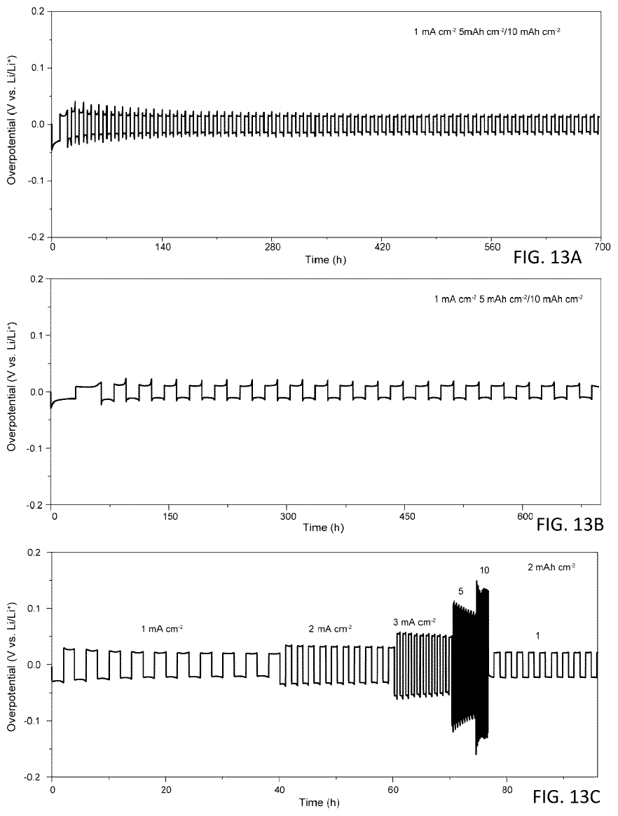

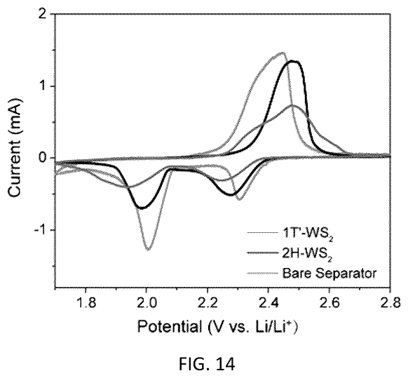

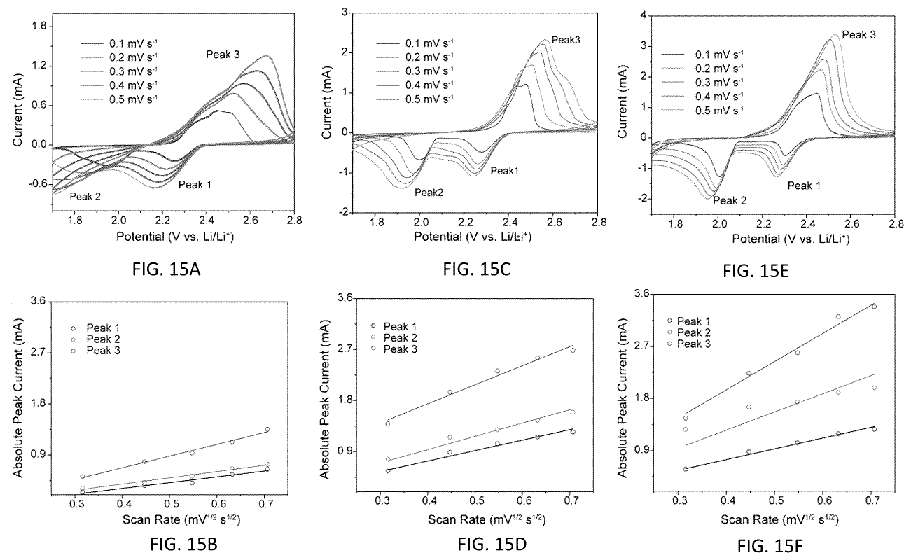

The CV technique was used to study the processes and the kinetics of the reaction. For the cell with a separator modified with 1T′-WS₂, two intensive peaks at 2.30 V and 2.00 V (FIG. 14) in the cathodic scan could be ascribed to the reduction of the kinetics of the reaction. The slopes of the curves (Iₚ/v^{0.5}) were positively correlated with the diffusion coefficients according to the Randles-Sevick equation, where Iₚ was the peak current and the v was the scanning rate. Among all the cells, the peak currents of the cell based on the separator modified with 1T′-WS₂ were the highest sulfur to long-chain soluble LPSs and further conversion to short-chain insoluble Li₂S₂/Li₂S. In the subsequent anodic scan, a strong peak located at 2.45 V is associated with the oxidation process of Li₂S₂/Li₂S. In sharp contrast, the intensities of the redox peaks are much smaller, and larger voltage intervals between the oxidation and reduction peaks could be observed in the cell equipped with the bare separator and 2H-WS₂ modified separator as compared with that of 1T′-WS₂ based Li—S battery, exhibiting sluggish kinetics in the redox reaction. The CV curves were scanned at various rates to and the corresponding slopes were the largest in the redox reactions (FIGS. 15A to 15F), demonstrating a higher lithium-ion diffusion rate on the surface of 1T′-WS₂.

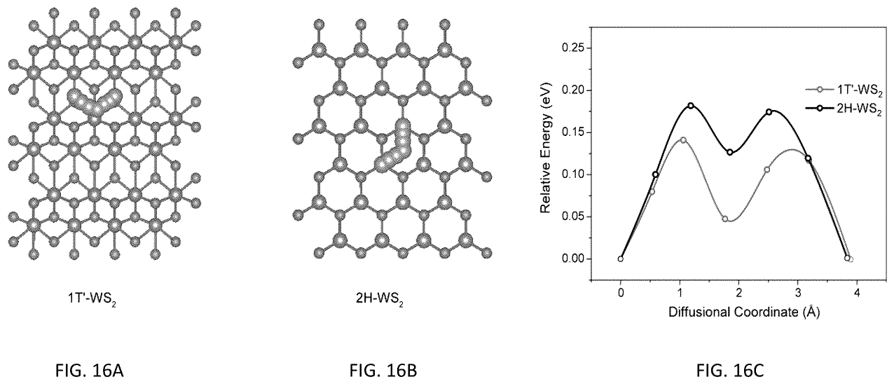

To obtain a deep understanding of the enhanced kinetics, the hopping process of Li ions in the adjacent space units on the crystals was simulated (FIGS. 16A and 16B). The energy barrier on the 1T′-WS₂ was only 0.14 eV (FIG. 16C), which was much lower than that of 2H-WS₂ (0.18 V). The enhanced kinetics were beneficial for the fast conversion of LiPSs in the battery, resulting in the high capacity and rate capability of the cathode under lean electrolyte.

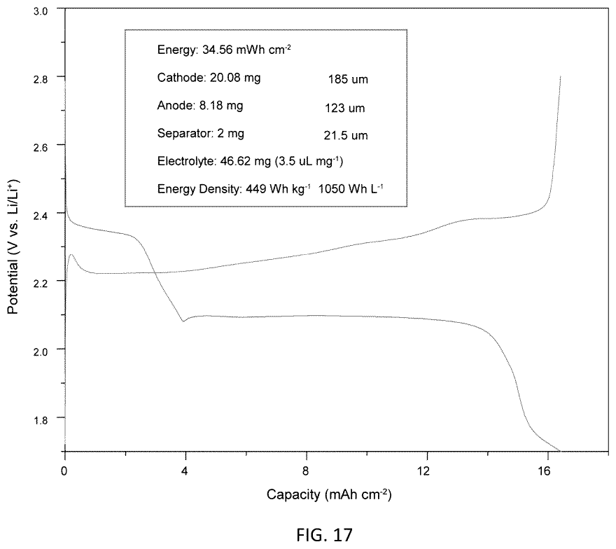

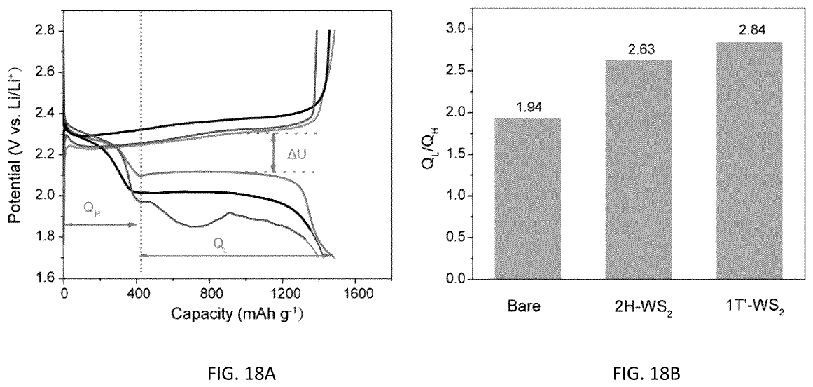

The cells were firstly cycled at 0.05 C (1 C=1675 mA g⁻¹) to activate all the S in the cells. The GCD profiles of the cell with a 1T′-WS₂ modified separator under high mass loading of 12 mg cm⁻² is displayed in FIG. 17. The insert exhibits the detailed information and estimation of energy density of the cell. Typical GCD profiles for different types of cells are displayed in FIG. 18A. In the discharge process, the cell with a 1T′-WS₂ modified separator delivered a large capacity of 1488 mAh g⁻¹, which was much higher than the cell with a bare separator (1458 mAh g⁻¹) and separator modified by the conventional sulfide (1400 mAh g⁻¹). Meanwhile, the voltage potential gap between the charging and discharging processes in the cell with 1T′-WS₂ was the smallest among all the samples, which further proved the enhanced kinetics of the redox reaction. To further prove the high conversion and utilization of active S in the full cell, the discharge capacity was divided into two parts: the high plateau capacity (Q_{H}) and the lower plateau capacity (Q_{L}). At high voltage, the sulfur could be reduced to soluble Li₂S₄, which can contribute ¼ of the theoretical capacity (Q_{H}). Then, Li₂S₄ could be further reduced to solid Li₂S/Li₂S₂ at a lower voltage, which could contribute around ¾ of the theoretical capacity (Q_{L}). Thereby, the ratio Q_{L}/Q_{H} could be used to quantify the conversion and accumulation of the polysulfides in the electrolyte. In the cell with 1T′-WS₂, this value can reach 2.84, which is much higher than that of batteries based on a bare separator (1.94) and a 2H-WS₂ separator (2.63), implying that a larger amount of LiPSs can be catalytically converted to solid Li₂S by the 1T′-WS₂ (FIG. 18B).

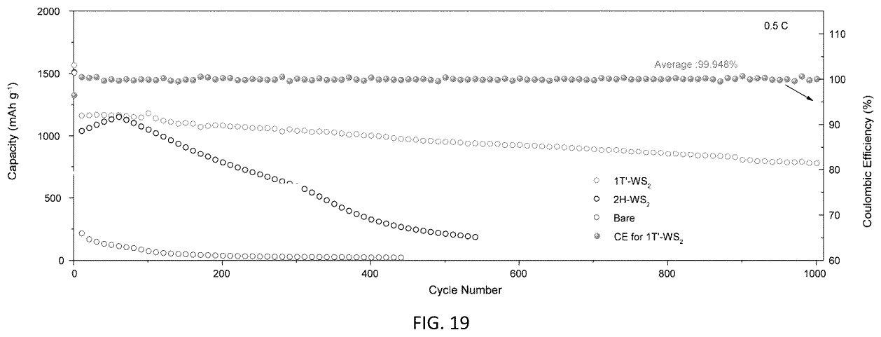

The current density was increased to 0.5 C to evaluate the long cycling stability of the cells. The capacity of cells with 2H-WS₂ dropped below 1000 mAh g⁻¹ after the switch of current and ˜80% of initial capacity was lost during the first 500 cycles (FIG. 19), referring to a poor coulombic efficiency of 97.7%. As for the cell with a bare separator, the initial capacity can only reach ˜230 mAh g⁻¹ due to the sluggish reaction kinetics, and almost all the capacity decays within the initial 200 cycles. In sharp contrast, the cell with the inventive 1T′-WS₂ can still deliver an ultrahigh capacity of 1173 mAh g⁻¹ and more than 72% of the initial capacity is maintained after 1000 cycles, corresponding to an average coulombic efficiency of 99.95%.

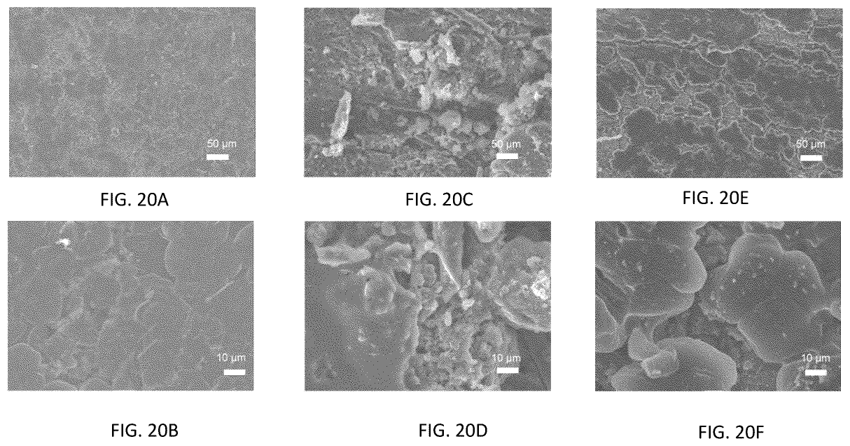

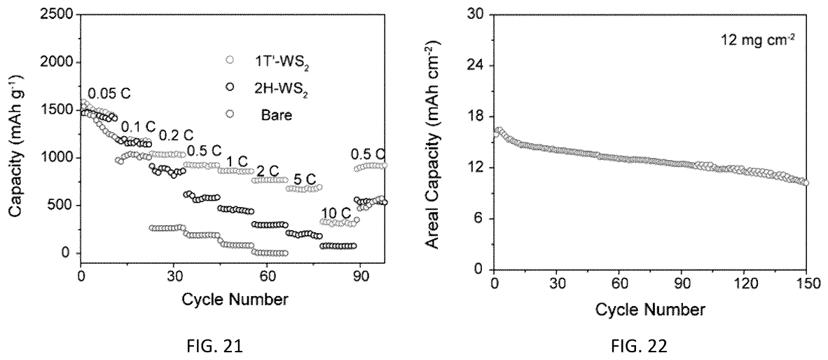

The cell was further disassembled to monitor the Li metal after cycling. The cycled Li anode based on 1T′-WS₂ showed a rather smooth surface (FIGS. 20A and 20B), while serious corrosion and pulverization is observed on the Li metal anodes in the cell with a 2H-WS₂ based separator (FIGS. 20C and 20D) and a bare separator (FIGS. 20E and 20F), further demonstrating shuttle-free properties of liquid LPSs during cycling due to the enhanced trapping and blocking of LiPSs from the unconventional 1T′-WS₂.

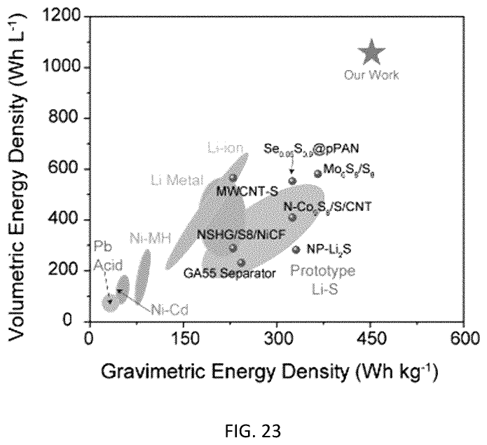

The metallic conductivity and improved kinetics may lead to fast redox of the LiPSs, which further resulted in an improved rate performance. The 1T′-WS₂ based battery delivered specific capacities of 1488, 1183, 1037, 921, 860, 768, 672 and 312 mAh g⁻¹ at current densities of 0.05, 0.1, 0.2, 0.5, 1, 2, 5 and 10 C, respectively (FIG. 21). When the current density turned back from 10 C to 0.5 C, a high stable capacity of 919 mAh g⁻¹ was recovered, revealing the high reversibility of the cell. The 2H-WS₂ based battery showed a comparable capacity to that of the 1T′-WS₂ based battery at low rates (1448 mAh g⁻¹ @0.05 C). However, due to the semiconducting properties and the low catalytic activity of the conventional phases, it could only deliver a much lower specific capacity at higher rates (570 mAh g⁻¹@0.5 C, 456 mAh g⁻¹@ 1 C, 296 mAh g⁻¹@2 C, 207 mAh g⁻¹@5 C). As for the battery based on the bare separator, the performance was worse. When the currents increased to 0.2 C, the capacity suddenly dropped from 1034 mAh g⁻¹ to 261 mAh g⁻¹, due to the low kinetics in the battery without catalytic layers.

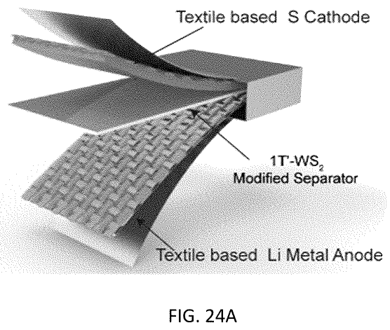

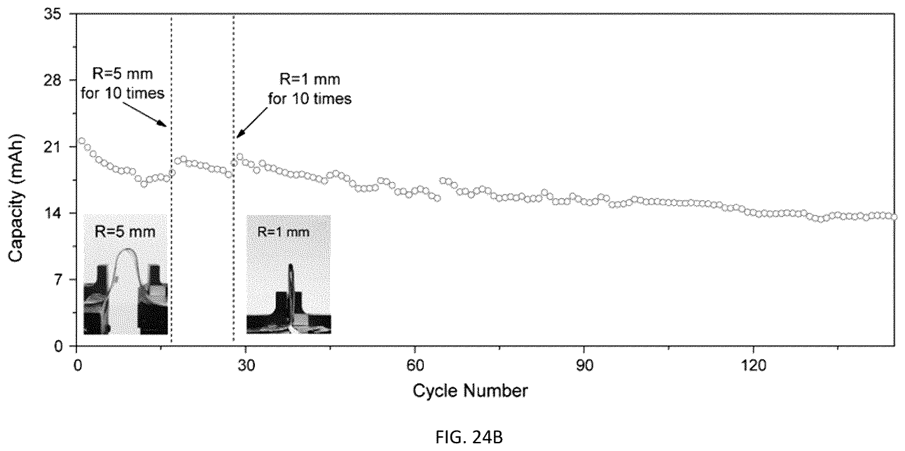

Under a high mass loading of 12 mg cm², the 1T′-WS₂ based battery exhibited an initial areal capacity of 15.9 mAh g⁻¹ and could maintain a reasonable capacity of 10.5 mAh cm⁻² after 150 cycles (FIG. 22), demonstrating a satisfactory cycling stability. From the charge and discharge curves of the cell, no signs of shuttling of the LiPSs can be observed, further confirming the selective pass of Li ions in the modification layer. Taking all the components into account, the 1T′-WS₂ based battery delivers an ultrahigh energy density of 448 Wh kg⁻¹ (1050 Wh L⁻¹), which outperforms the current battery technologies including the Li-ion battery, nickel-metal hydride battery (Ni-MH), Ni—Cd battery and prototype Li—S battery, and is also better than other Li—S systems such as Mo₆S₈/S₈, MWCNT@S and NSHG/S₈/NiCF (FIG. 23).

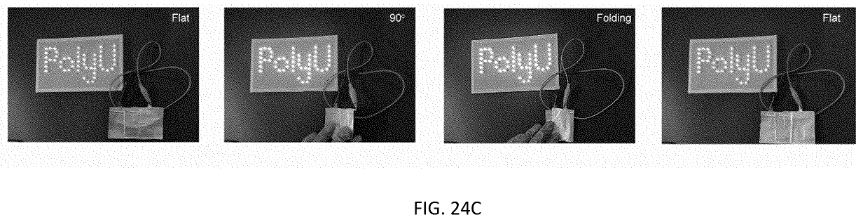

The self-assembling of the 1T′-WS₂ can effectively increase the mechanical robustness of the modification layer. Therefore, it was promising to apply the separator to a flexible battery to power the emerging area of flexible electronics. As a proof of concept, flexible batteries were assembled with textile-based S cathodes and Li metal anodes (FIG. 24A). The charge and discharge processes were recorded at 1 mA cm⁻² for the 145 cycles during which 10 repeating bending at 5 mm and 1 mm radius were carried out (FIG. 24B). The high-capacity retention of ˜99.5% and small fluctuations during mechanical bending indicated the excellent mechanical stability of the Li—S full batteries. Two batteries were further connected in series to yield a high open voltage of 4.2 V to power a screen displaying “POLYU” to demonstrate its practical application. As shown in FIG. 24C, the letters were well displayed and no obvious change in brightness could be monitored at different flexing states, showing stability in an electronic device application.

By using 1T′-TMDs to build high-energy and stable Li—S batteries, the cells exhibited high energy density (448 Wh kg⁻¹, 1050 Wh L⁻¹), high areal capacity (15.9 mAh cm⁻²), and excellent stability (capacity retention: 99.96% per cycle for 1000 cycles). Moreover, the cells can maintain stable charge/discharge characteristics after being repeatedly bent at small radii of curvature. The excellent electrochemical performance can be ascribed to the unique properties of the unconventional 1T′-TMDs.

The embodiments may be chosen and described in order to best explain the principles of the invention and its practical application, thereby enabling others skilled in the art to understand the invention for various embodiments and with various modifications that are suited to the particular use contemplated. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations. While the apparatuses disclosed herein have been described with reference to particular structures, shapes, materials, composition of matter and relationships . . . etc., these descriptions and illustrations are not limiting. Modifications may be made to adapt a particular situation to the objective, spirit and scope of the present disclosure. All such modifications are intended to be within the scope of the claims appended hereto.

What is claimed is:

1. A high energy-density lithium-sulfur battery comprising:
a cathode including sulfur;
an anode including lithium metal; and
a separator positioned between the cathode and the anode, the separator being modified by a self-assembled 1T′-phase transition metal dichalcogenide layer.

2. The high energy-density lithium-sulfur battery of claim 1, further comprising an electrolyte in an amount constituting a lean electrolyte battery condition.

3. The high energy-density lithium-sulfur battery of claim 2, wherein the electrolyte is a lithium-containing electrolyte.

4. The high energy-density lithium-sulfur battery of claim 1, wherein the 1T′-phase transition metal dichalcogenides include one or more of WS₂, WSe₂, MoS₂, MoSe₂, WS₂ₓSe₂₍₁₋ₓ₎, MoS₂ₓSe₂₍₁₋ₓ₎, TaS₂, TaSe₂, TiS₂, TiSe₂, ReS₂, ReSe₂, NbS₂, and NbSe₂.

5. The high energy-density lithium-sulfur battery of claim 1, wherein the 1T′-phase transition metal dichalcogenide layer does not include additional conductive materials.

6. The high energy-density lithium-sulfur battery of claim 1, wherein the separator is a polypropylene or polyethylene separator.

7. The high energy-density lithium-sulfur battery of claim 1, wherein the battery has an energy density of at least 400 Wh kg⁻¹ and 820 Wh L⁻¹.

8. A method of making a high energy-density lithium-sulfur battery, comprising:
provide a cathode including sulfur;
providing an anode including lithium metal;
positioning a separator between the cathode and the anode, the separator being fabricated by:
filtering a suspension including 1T′-phase transition metal dichalcogenides through a porous separator such that the 1T′-phase transition metal dichalcogenides self-assemble to form a 1T′-phase transition metal dichalcogenide layer on the porous separator.

9. The method of making the high energy-density lithium-sulfur battery of claim 8, wherein the 1T′-phase transition metal dichalcogenides include one or more of WS₂, WSe₂, MoS₂, MoSe₂, WS₂ₓSe₂₍₁₋ₓ₎, MoS₂ₓSe₂₍₁₋ₓ₎, TaS₂, TaSe₂, TiS₂, TiSe₂, ReS₂, ReSe₂, NbS₂, and NbSe₂.

10. The method of making the high energy-density lithium-sulfur battery of claim 8, wherein the suspension including 1T′-phase transition metal dichalcogenides is a suspension of 1T′-phase transition metal dichalcogenide flakes.

11. The method of making the high energy-density lithium-sulfur battery of claim 8, wherein the 1T′-phase transition metal dichalcogenide layer does not include additional conductive materials.

12. The method of making the high energy-density lithium-sulfur battery of claim 8, wherein the separator is a polypropylene or polyethylene separator.

13. The method of making the high energy-density lithium-sulfur battery of claim 8, further comprising adding an electrolyte to the battery in an amount constituting a lean electrolyte battery condition.
